(19) United States
(12) Patent Application Publication
(10) Pub. No.: US 2002/0020297 A1
(43) Pub. Date: Feb. 21, 2002

(54) Method and device for air purification

(76) Inventors: Peter A. Harris, Boston, MA (US); David M. Lupo, East Falmouth, MA (US)

Correspondence Address: PENNIE & EDMONDS LLP, 1667 K STREET NW, SUITE 1000, WASHINGTON, DC, 20006

(21) Appl. No.: 09/907,815

(22) Filed: Jul. 19, 2001

Related U.S. Application Data
(60) Provisional application No. 60/221,592, filed on Jul. 27, 2000.

(51) Int. Cl. B01D 46/00

(52) U.S. Cl. 95/273; 55/467; 55/482; 96/224

(57) ABSTRACT

Novel air purification devices are disclosed. Preferred devices comprise air inlets and outlets separated by a significant distance and at least one filter. Other preferred devices comprise a radiation source and at least one filter. Also disclosed are novel methods of purifying air.

This application claims priority to U.S. provisional application No. 60/221,592 filed Jul. 27, 2000, the entirety of which is incorporated herein by reference.

### FIELD OF THE INVENTION

This invention is related to methods and devices for purifying air effectively and efficiently by removing airborne pollutants.

### BACKGROUND OF THE INVENTION

It is estimated that in the U.S. approximately 12 million people suffer from asthma. The Merck Manual, p. 557 (17^{th} ed.; 1999). From 1982 to 1992, the prevalence of asthma increased from 3.47 percent to 4.94 percent, and the death rate due to asthma increased 40 percent, from 13.4 to 18.8 per million. Id. Asthma is also the leading cause of hospitalization for children, and the number one chronic condition causing school absenteeism. Id.

Like allergic reactions, asthma attacks can be induced by a variety of airborne pollutants, such as dust, pollen, tobacco smoke, pet hair and dandruff, fabric and carpet fibers, bacteria, and mold spores. Id. at 560-562. Unfortunately, the number and types of airborne pollutants typically increases each year, especially in urban environments. Recognizing the increasing need for pure air in both home and office environments, manufacturers now sell a variety of air purification devices.

Commercially available air purification devices are typically of two types: small, portable devices; and large-scale devices integrated with the central air conditioning systems of, for example, apartment buildings. Examples of portable air purification devices include those disclosed by U.S. Patent Nos. 4,376,642, 4,629,482, and 5,435,817.

Most air purification devices draw air through an inlet and at least one filter, and expel the filtered air from an outlet. Some of the portable air purification devices which are currently available use two filters: a charcoal filter and a high efficiency particulate air (HEPA) filter. HEPA filters can remove 99.97% of particles that are 0.3 microns or larger in diameter. Unfortunately, even the currently available devices that employ HEPA filters suffer from a number of problems that limit their ability to adequately remove airborne pollutants. For example, the air inlet and outlet in typical air purification devices are positioned next to each other, such that filtered air will quickly re-enter the device, thereby reducing its efficiency. The airflow patterns created by typical air purification devices also cause a random scattering of airborne particles that reduces cleaning efficiency. The efficiency of conventional devices is further reduced by their relatively small air inlets and corresponding small airflow volume. The efficiency of central air purification devices, which are typically linked to environmental temperature (e.g., via central air conditioning controls), is further limited by their intermittent operation. In addition, centralized air purification systems typically filter only a small percentage of total airflow through HEPA filtration, which limits their cleaning efficiency.

Thus, there exists a need for improved air purification devices, as well as improved methods of purifying air. In particular, there exists a need for air purification devices that are more efficient than the portable ones currently on the market, but which need not be integrated with central air conditioning systems. There further exits a need for efficient and effective single-room air purification devices.

### SUMMARY OF THE INVENTION

This invention provides novel methods and devices for the purification of air. For example, a first embodiment of the invention encompasses an air purification device which comprises a casing defining an air cleaning path and having an air inlet, an air outlet, a bottom, and a top; a first filter disposed across the air cleaning path and between the air inlet and air outlet; and a fan disposed along the air cleaning path for moving air from the air inlet to the air outlet; wherein the air inlet is located closer to the bottom of the casing than it is to the top of the casing, the air outlet is located closer to the top of the casing than it is to the bottom of the casing, and the distance between the air inlet and air outlet is greater than about 20 inches (51 cm). A preferred air purification device has only one air outlet.

In a preferred air purification device of this embodiment, the distance between the air inlet and air outlet is from about 20 inches (51 cm) to about 60 inches (147 cm), more preferably from about 24 inches (61 cm) to about 54 inches (132 cm), and most preferably from about 30 inches (76 cm) to about 48 inches (122 cm).

Another preferred air purification device of this embodiment further comprises a radiation source disposed along the air cleaning path. Preferably, the radiation is ultraviolet radiation. Preferably, the radiation source is a source of radiation having an intensity of greater than about 100 μW/cm². In a more preferred air purification device, the radiation has an intensity of from about 100 μW/cm² to about 300 μW/cm², more preferably from about 150 μW/cm² to about 260 μW/cm², and most preferably from about 180 μW/cm² to about 240 μW/cm².

Another preferred air purification device of this embodiment comprises a second filter disposed across the air cleaning path and between the air inlet and air outlet. A more preferred air purification device further comprises a third filter disposed across the air cleaning path and between the air inlet and air outlet. A specific preferred air purification device comprises a first filter, a second filter, and a third filter, wherein the first filter is a pre-filter, the second filter is an activated carbon filter, and the third filter is a HEPA filter.

In another preferred air purification device of this embodiment, the fan moves air from the air inlet to the air outlet at a rate of greater than about 100 ft³/min. In a more preferred air purification device, the fan moves air from the air inlet to the air outlet at a rate of from about 100 ft³/min to about 450 ft³/min, even more preferably from about 175 ft³/min to about 350 ft³/min, and most preferably from about 250 ft³/min to about 300 ft³/min.

A second embodiment of the invention encompasses an air purification device which comprises a casing defining an air cleaning path and having an air inlet, an air outlet, a bottom, and a top; a first filter disposed across the air cleaning path and between the air inlet and air outlet; a fan disposed along the air cleaning path for moving air from the air inlet to the air outlet; and a radiation source disposed along the air cleaning path; wherein the air inlet is located closer to the bottom of the casing than it is to the top of the casing, the air outlet is located closer to the top of the casing than it is to the bottom of the casing. A preferred air purification device has only one air outlet.

Preferably, the radiation is ultraviolet radiation, and a preferred source of radiation has an intensity of greater than about 100 μW/cm². In a more preferred air purification device, the radiation has an intensity of from about 100 μW/cm² to about 300 μW/cm², more preferably from about 150 μW/cm² to about 260 μW/cm², and most preferably from about 180 μW/cm² to about 240 μW/cm².

In a preferred air purification device of this embodiment, the distance between the air inlet and air outlet is from about 20 inches (51 cm) to about 60 inches (147 cm), more preferably from about 24 inches (61 cm) to about 54 inches (132 cm), and most preferably from about 30 inches (76 cm) to about 48 inches (122 cm).

Another preferred air purification device of this embodiment comprises a second filter disposed across the air cleaning path and between the air inlet and air outlet. A more preferred air purification device of this embodiment further comprises a third filter disposed across the air cleaning path and between the air inlet and air outlet. A specific preferred air purification device comprises a first filter, a second filter, and a third filter, wherein the first filter is a pre-filter, the second filter is an activated carbon filter, and the third filter is a HEPA filter.

In a preferred air purification device of this embodiment, the fan moves air from the air inlet to the air outlet at a rate of greater than about 100 ft³/min. In a more preferred air purification device, the fan moves air from the air inlet to the air outlet at a rate of from about 100 ft³/min to about 450 ft³/min, even more preferably from about 175 ft³/min to about 350 ft³/min, and most preferably from about 250 ft³/min to about 300 ft³/min.

A third embodiment of the invention comprises a method of purifying air in a room having a floor and a ceiling which comprises drawing air through a casing defining an air cleaning path and having an air inlet and an air outlet; wherein a first filter is disposed across the air cleaning path and between the air inlet and air outlet and wherein the air inlet is located in the room and closer to the floor than it is to the ceiling, the air outlet is located in the room and closer to the ceiling than it is to the floor, and the distance between the air inlet and air outlet is greater than about 20 inches (51 cm). A preferred method of this embodiment employs an air purification device of the invention.

A fourth embodiment of the invention comprises a method of purifying air in a room having a floor and a ceiling which comprises drawing air through a casing defining an air cleaning path and having an air inlet and an air outlet; wherein a first filter is disposed across the air cleaning path and between the air inlet and air outlet, and a radiation source is disposed along the air cleaning path between the air inlet and air outlet, and wherein the air inlet is located closer to the floor than it is to the ceiling and the air outlet is located closer to the ceiling than it is to the floor. A preferred method of this embodiment employs an air purification device of the invention.

### BRIEF DESCRIPTION OF THE DRAWINGS

To better understand novel aspects of the invention, reference can be made to the figures described below:

FIG. 1 illustrates a cutaway side-view of an air purification device of the invention;

FIG. 2 illustrates a cutaway side-view of an alternative air purification device of the invention;

FIG. 3 illustrates a back-view, a side-view, and a front view of an air purification device of the invention;

FIG. 4 illustrates a top-view of an air purification device of the invention; and

FIG. 5 illustrates a room containing two air purification devices of the invention.

### DETAILED DESCRIPTION

This invention is based on the discovery that highly efficient air purification can be achieved by positioning the inlet of an air purification device near the floor of a room and its outlet near at or above the height of the room's occupants. The invention is further based on the realization that separating the distance between the air inlet and air outlet ports of an air purification device by greater than about 20 inches (51 cm) can substantially increase its efficiency. It has also been discovered that while filters can remove a variety of particles from the air, the quality of filtered air can be further improved if it is also exposed to radiation. For example, it has been found that the use of ultraviolet radiation can ensure the death or damage of microbes, spores, and other biological material capable of passing through even HEPA filters.

A preferred air purification device of the invention therefore comprises an air inlet positioned near the bottom of the device, an air outlet positioned a significant distance above it, and at least one filter. Another preferred air purification device comprises a radiation source and at least one filter. A particularly preferred device of the invention comprises an air outlet positioned a significant distance above its air inlet, at least two filters, and a radiation source.

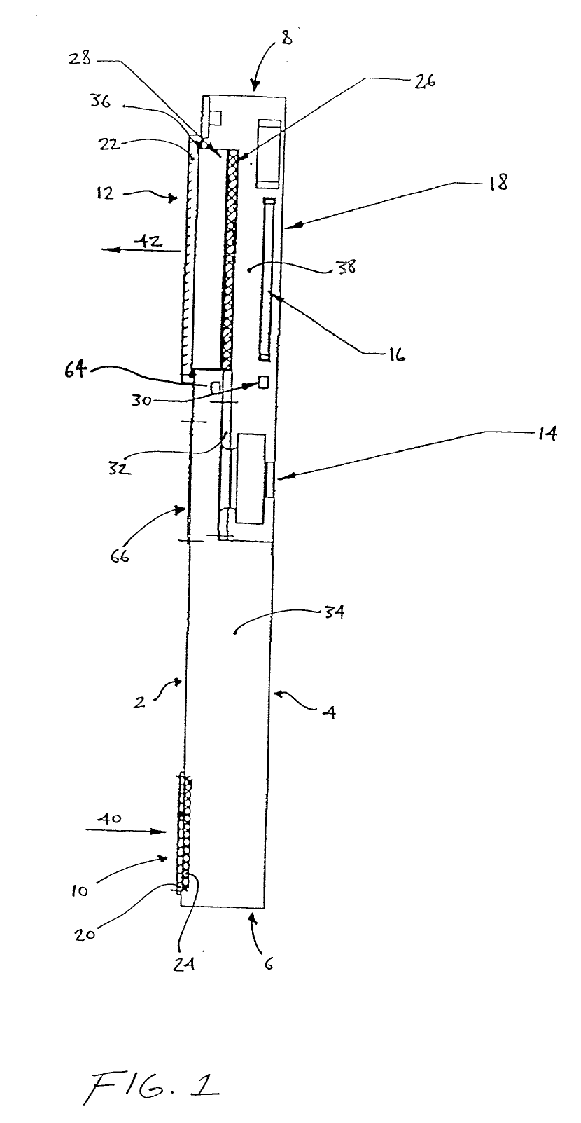

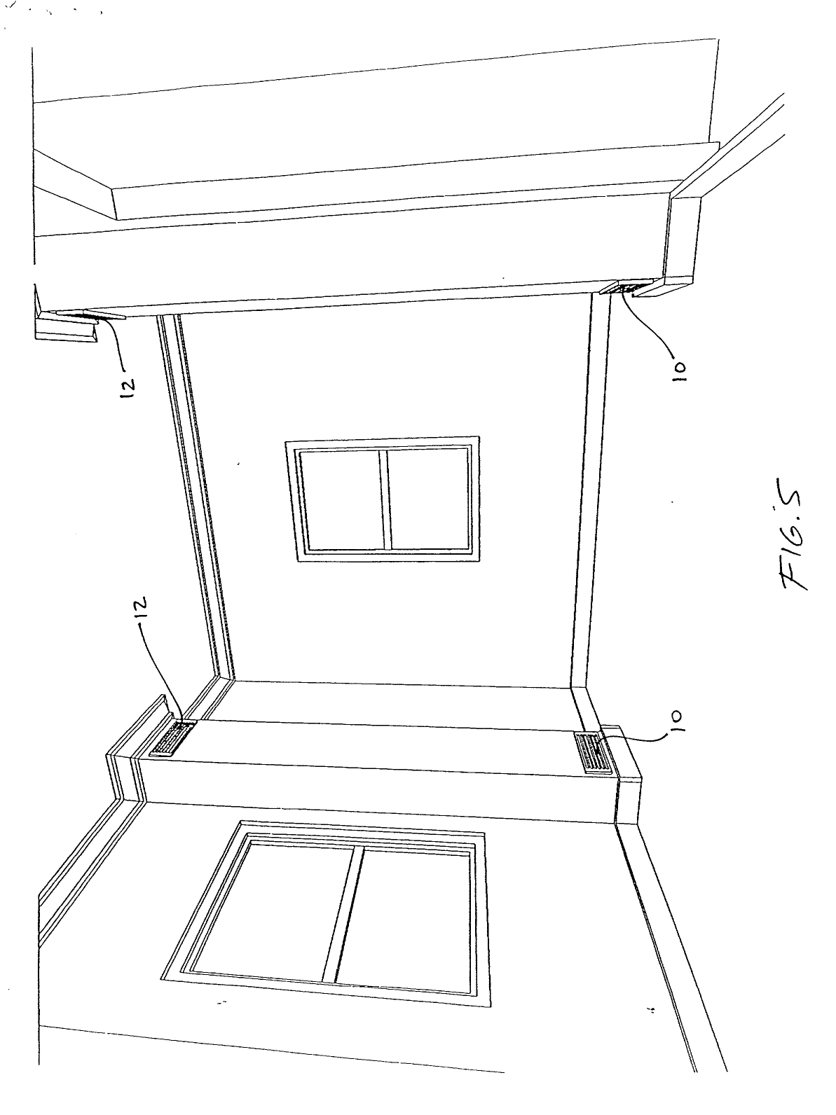

While the novel aspects of this invention can readily be incorporated into devices of innumerable shapes and sizes, a preferred air purification device is represented by FIGS. 1-4. Its incorporation into a room is shown in FIG. 5.

FIG. 1 shows a cutaway side-view of a preferred air purification device. As shown in FIG. 1, the preferred air purification device has a substantially air-tight shell 18, which has a front 2, a back 4, a bottom 6, and a top 8. The casing can be made of any suitable material such as, but not limited to, metal (e.g., aluminum or steel) and plastic. Close to the bottom 6 of the casing 18, there exists an air inlet 10, which is covered by an inlet screen 20, behind which is a pre-filter 24. When the air purification device is operating, air 40 is drawn through the inlet screen 20 and pre-filter 24, and into a negative pressure plenum 34.

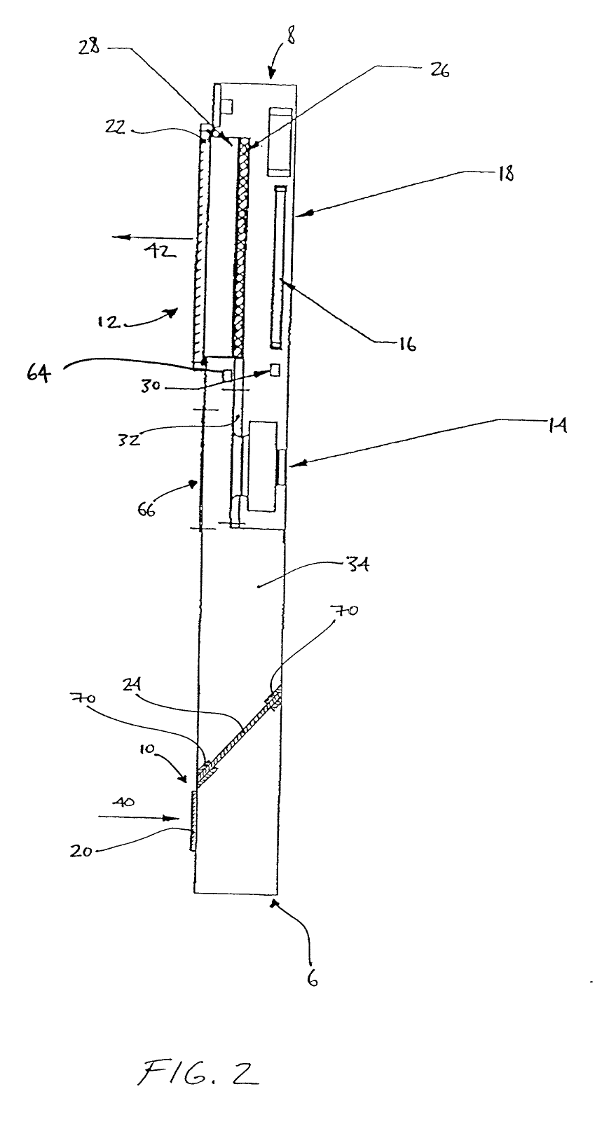

FIG. 2 shows a cutaway side-view of an alternative preferred air purification device, wherein the pre-filter 24 is not parallel or adjacent to the screen 20. This embodiment allows the use of a pre-filter 24 that is larger than the size of the air inlet 10. To a point, the smaller the air inlet 10, the less noise is generated by the air purification device, while the larger the pre-filter 24, the less frequently it needs to be changed or cleaned. In this embodiment, the pre-filter 24 is held in place by slots, clips, or other fastening means 70 known to those skilled in the art.

The purpose of the pre-filter 24 is the elimination of large particles from the air that passes through the air purification device. Suitable materials from which the prefilter 24 can be made are well known to those skilled in the art and include, but are not limited to, paper fibers. Preferred pre-filters are made of pleated paper.

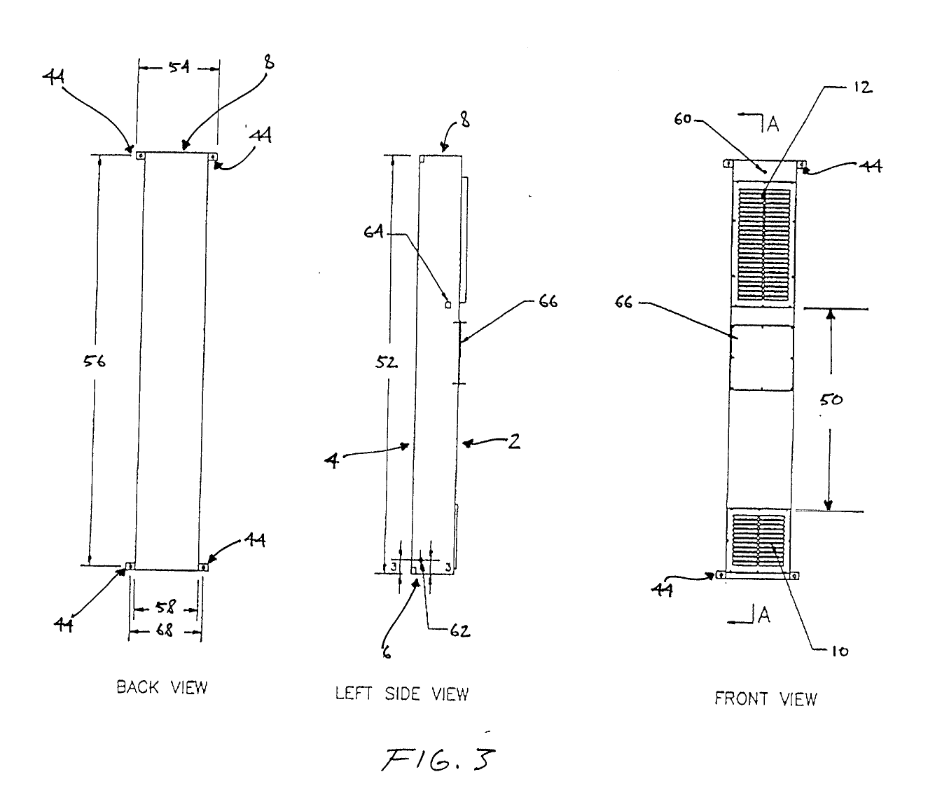

Referring again to FIG. 1, the negative pressure that is drawing the air 40 into the casing 18 of the air purification device is created by a centrifugal fan 14 mounted over an opening in an internal barrier 32. A preferred fan is a 240 watt, 450 ft³/min. at 2″ wg fan. The fan 14 can be accessed by an access door 66 located on the front 2 of the casing 18. As shown in FIG. 3, the activation of the fan 14 is controlled by a switch 64. The switch 64 is typically an on/off switch, but can also be a variable switch whereby the speed of the fan 14 can be controlled to regulate airflow capacity. In particular embodiments of the invention, the switch 64 can be operated by remote control (e.g. the speed of the fan can be operated by remote control).

As shown in FIGS. 1 and 2, once the air 40 has entered the negative pressure plenum 34, it passes through the fan and into a positive pressure plenum 38, where it is irradiated by an ultraviolet radiation source 16. A preferred ultraviolet radiation source 16 comprises one or more 615 T8 bulbs, available from General Electric Corp. The activation of the ultraviolet radiation source 16 is controlled by a switch 30. The switch 30 is typically an on/off switch, but can also be a variable switch whereby the intensity of the ultraviolet radiation source 16 can be controlled.

The air 42 is then expelled from the positive pressure plenum 38 via an air outlet 12 after passing through a second filter 26 and a third filter 28. Preferred second filters 26 are made of materials such as, but not limited to, charcoal. A most preferred second filter 26 contains activated carbon. Preferred third filters 28 are made of materials such as, but not limited to, fiberglass and woven paper. A most preferred third filter 28 is a HEPA filter. The HEPA filter cleans the air stream passing through it by mechanically trapping the particles that are too large to pass through the fine mesh of the filter, thereby eliminating airborne pollutants. The air outlet 12 is covered by an outlet screen 22.

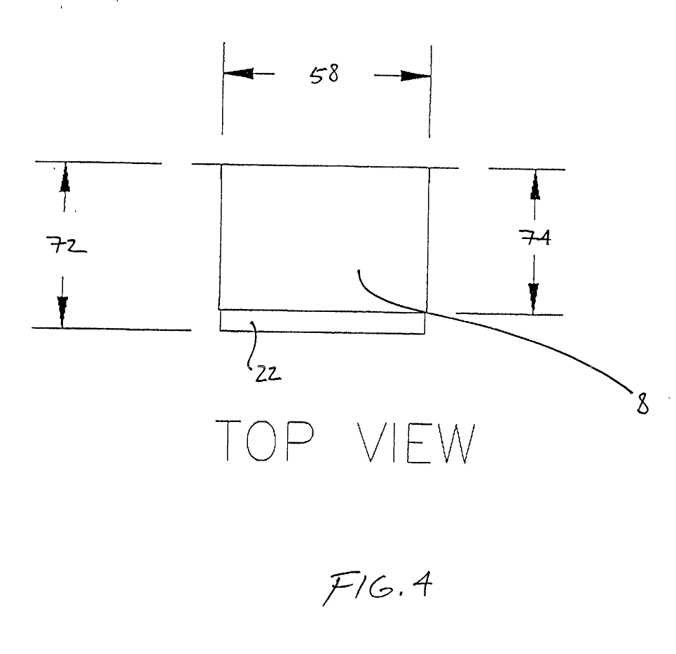

The unique ability of air purification devices of the invention to rapidly and efficiently purify air is due, in part, to the relative positions of their air inlets and outlets. This can be understood with reference to the dimensions of the specific air purification device shown in FIGS. 3-4. As shown in FIG. 3, the distance 50 between the air inlet 10 and air outlet 12 is about 44 inches (108 cm). In the particular embodiment shown, the height 56 of the air purification device is about 90 inches (221 cm), while the width 58 of the device is about 14 inches (34 cm).

Preferred air purification devices of the invention are capable of being mounted within walls, and in particular between wall studs. As shown in FIGS. 3 and 4, the full depth 72 of a typical air purification device is about 10 ⅞ inches (27 cm); the depth 74 of the device not including the outlet screen 22 is about 9.5 inches (23 cm).

Preferred air purification devices of the invention are also capable of being mounted on walls. Referring again to FIG. 3, a preferred device has mounting flanges 44 attached to the back 4 of the device, near its top 8 and bottom 6. The distance 68 between the holes in the mounting flanges 44 near the bottom 6 of the device is about 16 inches (39 cm); the distance between the mounting flanges 44 near the top 8 of the device is preferably the same. The distance 54 between the outside edges of the mounting flanges 44 near the top 8 of the device is about 18 inches (44 cm); the distance between the outside edges of the mounting flanges 44 near the bottom 6 of the device is preferably the same.

FIG. 5 shows a room containing two devices of the invention mounted to opposing walls. This arrangement has been found to be particularly effective in the purification of air for two reasons. First, because the air outlets 12 are located near the ceiling of the room, the clean air expelled by the air outlets 12 forces airborne particles down to the floor, where they are drawn into the inlet 10. This process can occur with the use of only one air purification device of the invention. But because the air expelled from the outlet 12 is expelled away from the device, it will travel not only towards the floor, but also towards an opposite wall, during which time it will pick-up airborne particles. If a second air purification device is mounted on the opposite wall, these airborne particles will be drawn into its inlet 10. It is thus apparent that the use of two air purification devices of the invention provides an airflow pattern within a room that yields a particularly efficient reduction or elimination of airborne particles. The air within the room circulates through the two air purification devices frequently to ensure continuous removal of pollutants.

As those skilled in the art will readily recognize, this invention is not limited to the details provided above or shown in the attached figures. Instead, the invention is best understood with reference to the following claims.

What is claimed is:

1. An air purification device which comprises:
a casing defining an air cleaning path and having an air inlet, an air outlet, a bottom, and a top;
a first filter disposed across the air cleaning path and between the air inlet and air outlet; and
a fan disposed along the air cleaning path for moving air from the air inlet to the air outlet; wherein the air inlet is located closer to the bottom of the casing than it is to the top of the casing, the air outlet is located closer to the top of the casing than it is to the bottom of the casing, and the distance between the air inlet and air outlet is greater than about 20 inches.

2. The device of claim 1 wherein the distance between the air inlet and air outlet is from about 20 inches to about 60 inches.

3. The device of claim 1 which further comprises a radiation source disposed along the air cleaning path.

4. The device of claim 3 wherein the radiation source is a source of radiation having an intensity of greater than about 100 μW/cm².

5. The device of claim 1 which further comprises a second filter disposed across the air cleaning path and between the air inlet and air outlet.

6. The device of claim 5 which further comprises a third filter disposed across the air cleaning path and between the air inlet and air outlet.

7. The device of claim 6 wherein the first filter is a pre-filter, the second filter is an activated carbon filter, and the third filter is a HEPA filter.

8. The device of claim 1 wherein the fan moves air from the air inlet to the air outlet at a rate of greater than about 100 ft³/min.

9. An air purification device which comprises:
a casing defining an air cleaning path and having an air inlet, an air outlet, a bottom, and a top;
a first filter disposed across the air cleaning path and between the air inlet and air outlet;
a fan disposed along the air cleaning path for moving air from the air inlet to the air outlet; and
a radiation source disposed along the air cleaning path; wherein the air inlet is located closer to the bottom of the casing than it is to the top of the casing, the air outlet is located closer to the top of the casing than it is to the bottom of the casing.

10. The device of claim 9 wherein the radiation source is a source of radiation having an intensity of greater than about 100 μW/cm².

11. The device of claim 10 wherein the radiation has an intensity of from about 100 μW/cm² to about 300 μW/cm².

12. The device of claim 9 wherein the distance between the air inlet and air outlet is greater than about 20 inches.

13. The device of claim 9 wherein the distance between the air inlet and air outlet is at least 20 inches.

14. The device of claim 14 wherein the distance between the air inlet and air outlet is from about 20 inches to about 60 inches.

15. A method of purifying air in a room having a floor and a ceiling which comprises drawing air through a casing defining an air cleaning path and having an air inlet and an air outlet; wherein a first filter is disposed across the air cleaning path and between the air inlet and air outlet and wherein the air inlet is located in the room and closer to the floor than it is to the ceiling, the air outlet is located in the room and closer to the ceiling than it is to the floor, and the distance between the air inlet and air outlet is greater than about 20 inches.

16. A method of purifying air in a room having a floor and a ceiling which comprises drawing air through a casing defining an air cleaning path and having an air inlet and an air outlet; wherein a first filter is disposed across the air cleaning path and between the air inlet and air outlet, and a radiation source is disposed along the air cleaning path between the air inlet and air outlet, and wherein the air inlet is located closer to the floor than it is to the ceiling and the air outlet is located closer to the ceiling than it is to the floor.
